(19) United States
(12) Patent Application Publication
(10) Pub. No.: US 2011/0179254 A1
(43) Pub. Date: Jul. 21, 2011

(54) LIMITING SPECULATIVE INSTRUCTION FETCHING IN A PROCESSOR

(75) Inventors: Sherman H. Yip, San Francisco, CA (US); Martin R. Karlsson, San Francisco, CA (US); Shailender Chaudhry, San Francisco, CA (US)

(73) Assignee: SUN MICROSYSTEMS, INC., Santa Clara, CA (US)

(21) Appl. No.: 12/688,633

(22) Filed: Jan. 15, 2010

(51) Int. Cl. G06F 9/312; G06F 9/318

(52) U.S. Cl. 712/205; 712/239; 712/E09.033; 712/E09.035

(57) ABSTRACT

The described embodiments relate to a processor that speculatively executes instructions. During operation, the processor often executes instructions in a speculative-execution mode. Upon detecting an impending pipe-clearing event while executing instructions in the speculative-execution mode, the processor stalls an instruction fetch unit to prevent the instruction fetch unit from fetching instructions. In some embodiments, the processor stalls the instruction fetch unit until a condition that originally caused the processor to operate in the speculative-execution mode is resolved. In alternative embodiments, the processor maintains the stall of the instruction fetch unit until the pipe-clearing event has been completed (i.e., has been handled in the processor).

### BACKGROUND

1. Field

The described embodiments relate to computer systems. More specifically, the described embodiments relate to techniques for limiting speculative instruction fetching in a processor.

2. Related Art

Some modern microprocessors support speculatively executing program code. Although these processors can support a number of different speculative-execution modes, the speculative execution generally involves speculatively executing instructions while preserving a pre-speculation architectural state to enable the processor to discard speculative results and return to the pre-speculation architectural state in the event that a predefined operating condition (e.g., encountering an error/trap, a coherence violation, or a lack of resources, or executing certain types of instructions) occurs during speculative execution.

In some processors, upon encountering certain “pipe-clearing events” while speculatively executing instructions, the processor immediately terminates speculative execution, restores the pre-speculation architectural state, and resumes normal (i.e., non-speculative) execution. Generally, these pipe-clearing events are triggered by certain operating conditions or instructions encountered by the processor for which some of the stages of the instruction execution pipeline in the processor are cleared. For example, one type of pipe-clearing event is a pipe-clearing instruction, which is an instruction that is implemented such that the instruction always triggers a pipe-clear. When a pipe-clearing instruction is executed, the processor flushes the pipeline stages behind the instruction when the instruction has progressed through the pipeline stages and completed execution (e.g., instructions such as the DONE, RETRY, WRPR, or WRY instructions in the SPARC processor architecture from SPARC International Inc., of Menlo Park, Calif., USA). Another example of a pipe-clearing event is an error condition or a trap. For example, upon encountering a divide instruction for which the denominator is zero, the processor clears the pipe and handles a divide-by-zero trap.

Because the processor terminates speculative execution and restores the pre-speculation architectural state upon encountering a pipe-clearing event, the processor can encounter inefficiencies. One such inefficiency occurs when the processor issues prefetches or memory requests (e.g., TLB requests or requests for cache lines) while speculatively executing instructions and then encounters a pipe-clearing event. Because the pipe-clearing event causes the processor to immediately terminate speculative execution and restore the pre-speculation architectural state, any data subsequently returned by the prefetches, translation requests, or memory requests generated during speculative execution is discarded by the processor without being used to update the processor state. Thus, the computational work done by the processor's memory system in accessing and returning this data is wasted.

This effect can be worsened in processors where the processor restarts speculative execution if a condition that originally caused the processor to start speculative execution has not been resolved when the processor terminates speculative execution due to a pipe-clearing event. In these processors, if the condition has not been resolved, the processor can immediately restart speculative execution and again encounter the same (or a subsequent) pipe-clearing event. Each time the processor speculatively re-executes the same instructions, the processor can generate the same prefetch and memory requests. Thus, the processor can speculatively re-execute the same instructions multiple times, potentially flooding the memory system with numerous redundant requests.

### SUMMARY

The described embodiments relate to a processor that speculatively executes instructions. During operation, the processor executes instructions in a speculative-execution mode. Upon detecting an impending pipe-clearing event while executing instructions in the speculative-execution mode, the processor stalls an instruction fetch unit to prevent the instruction fetch unit from fetching additional speculative instructions and thereby potentially generating additional memory requests (e.g., cache line prefetches, TLB page entry requests, etc.).

In some embodiments, the processor stalls the instruction fetch unit until a condition that originally caused the processor to operate in the speculative-execution mode is resolved.

In some embodiments, the processor stalls the instruction fetch unit until the pipe-clearing event has been completed (i.e., has been handled in the processor).

In some embodiments, before releasing the stall, the processor restores the processor to a preserved architectural state that existed just before commencing executing instructions in the speculative-execution mode. In these embodiments, the processor can then resume operation in a normal-execution mode.

In some embodiments, when speculatively executing instructions, the processor uses one strand from a set of two or more strands on the processor to speculatively execute the instructions. In these embodiments, upon detecting an impending pipe-clearing event for the strand, the processor performs a per-strand stall of the instruction fetch unit to prevent the instruction fetch unit from fetching instructions for the strand and thereby potentially generating additional memory requests (e.g., cache line prefetches, TLB page entry requests, etc.).

In some embodiments, the processor releases the stall when an instruction or operating condition prevents the pipe-clearing event from being completed.

In some embodiments, speculatively executing instructions involves executing instructions in a scout mode, an execute-ahead mode, a branch-prediction mode, or another speculative-execution mode.

In some embodiments, the pipe-clearing event is caused by at least one of: (1) a pipe-clearing instruction; (2) a trap condition; (3) a miss for a delay slot for a branch; or (4) an operating condition that will cause the clearing of one or more stages of a pipeline in the processor.

### BRIEF DESCRIPTION OF THE FIGURES

FIG. 1A presents a block diagram of a computer system in accordance with the described embodiments.

FIG. 1B presents a block diagram of a processor in accordance with the described embodiments.

FIG. 1C presents a block diagram of a processor in accordance with the described embodiments.

FIG. 2 presents a block diagram of a fetch unit in accordance with the described embodiments.

FIG. 3 presents a flowchart illustrating a process for operating in a scout mode in accordance with the described embodiments.

FIG. 4 presents a flowchart illustrating a process for stalling a fetch unit upon detecting an impending pipe-clearing event in accordance with the described embodiments.

FIG. 5 presents a flowchart illustrating a process for stalling a fetch unit upon detecting an impending pipe-clearing event in accordance with the described embodiments.

In the figures, the same reference numerals refer to the same figure elements.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory and non-volatile memory, such as magnetic and optical storage devices such as disk drives, magnetic tape, CDs (compact discs), DVDs (digital versatile discs or digital video discs), or other media capable of storing data structures or code.

The methods and processes described in this detailed description can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules. In some embodiments, the hardware modules include one or more general-purpose circuits that are configured by executing instructions to perform some or all of the methods and processes.

### Overview

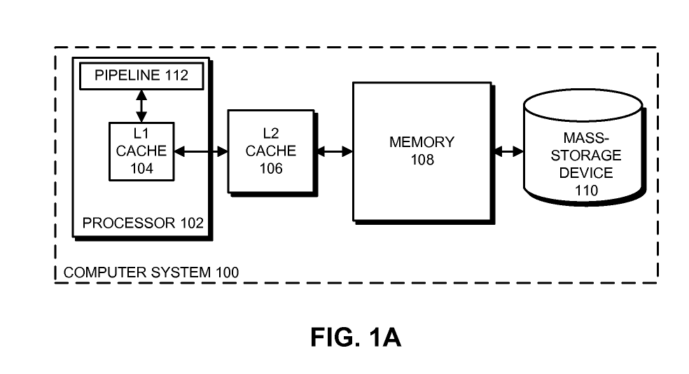

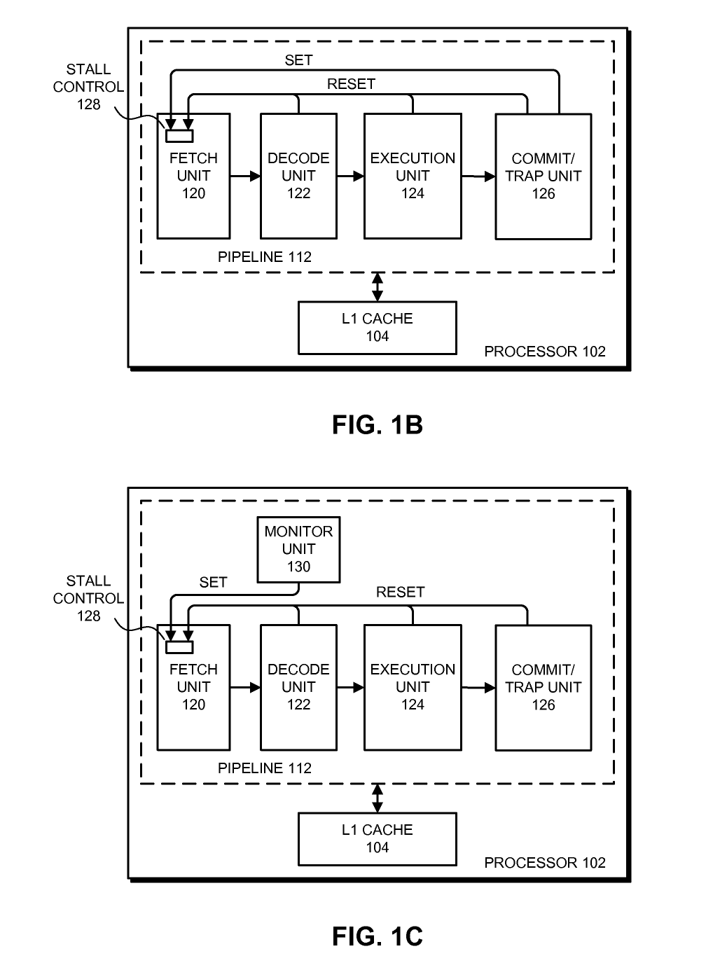

In the described embodiments, processor 102 (see FIG. 1) can encounter and process certain “pipe-clearing events.” Although different types of pipe-clearing events can be handled by processor 102, pipe-clearing events generally include any instruction and/or operating condition that causes processor 102 to clear (i.e., to flush instructions, intermediate results, etc. from) one or more stages in pipeline 112. For example, these pipe-clearing events can include, but are not limited to, pipe-clearing instructions, error conditions, traps/interrupts, and/or other operating conditions.

In the described embodiments, processor 102 also supports one or more speculative-execution modes. For example, processor 102 can support a scout mode, wherein instructions are speculatively executed to generate prefetches, but the results from the instructions (if any) are not committed to the architectural state. In addition, processor 102 can support an execute-ahead mode or a branch-prediction mode wherein instructions are speculatively executed during a data-dependent stall condition or a branch prediction to enable processor 102 to perform useful computational work until the data returns or until the branch resolution can be computed.

Note that, although we use these speculative-execution modes as examples, the described embodiments can support any of a number of different speculative-execution modes. Generally, speculative execution involves speculatively executing instructions while preserving a pre-speculation architectural state to enable the processor to discard speculative results and return to the pre-speculation architectural state in the event that an error condition occurs during speculative execution.

In the described embodiments, processor 102 monitors instruction execution for an indication that a pipe-clearing event is going to occur during speculative execution. For example, processor 102 can detect pipe-clearing instructions in the earliest stage in pipeline 112 where the pipe-clearing instruction can be clearly identified (e.g., a decode stage in pipeline 112), but before the pipe-clearing instruction has caused pipeline 112 stages to be cleared. In addition, processor 102 can detect an operating condition that will cause a trap and/or an error in a later stage (e.g., a commit/trap stage) of pipeline 112. For example, processor 102 can detect a division operation for which the denominator is zero in an execution stage and recognize the division operation as the source of a divide-by-zero trap in a commit/trap stage later in pipeline 112. Alternatively, processor 102 can detect a load miss for a delay slot for a branch.

In the described embodiments, upon determining that a pipe-clearing event is going to occur, processor 102 stalls a fetch unit in a pipeline in processor 102 to prevent fetch unit 120 from fetching instructions and thereby potentially generating additional memory requests (e.g., cache line prefetches, TLB page entry requests, etc.). Processor 102 maintains the stall of fetch unit 120 until either: (1) after the pipe-clearing event has been handled in pipeline 112, or (2) a stall condition that caused processor 102 to start speculatively executing instructions is resolved (i.e., until the speculative execution episode is complete). Processor 102 then terminates the scout mode, restores a pre-scout-mode architectural state of processor 102 (i.e., restores a checkpoint), and releases the stall of the fetch unit, enabling the fetch unit to continue fetching instructions in the normal-execution mode.

In these embodiments, by recognizing that the pipe-clearing event is going to occur and stalling the fetch unit during speculative execution, processor 102 avoids fetching (and potentially executing) instructions that will eventually be flushed from pipeline 112 when some or all of the stages of pipeline 112 is cleared when the pipe-clearing event is handled. This facilitates processor 102 avoiding sending memory requests (TLB page entry requests, cache line requests, etc.) when the underlying instruction is eventually going to be flushed from pipeline 112 during the pipe-clearing event, thereby rendering the value returned in response to the request useless. By avoiding sending the memory requests, these embodiments can avoid the situation that occurs in existing systems where a pipe-clearing event repeatedly causes a speculative episode to fail and be restarted, needlessly sending the same memory request(s) numerous times.

### Computer System

FIG. 1A presents a block diagram of a computer system 100 in accordance with the described embodiments. Computer system 100 includes processor 102, L2 cache 106, memory 108, and mass-storage device 110. Processor 102 includes L1 cache 104 and pipeline 112.

Processor 102 can include any device that is configured to perform computational operations. For example, processor 102 can be a central processing unit (CPU) such as a microprocessor, a controller, or an application-specific integrated circuit.

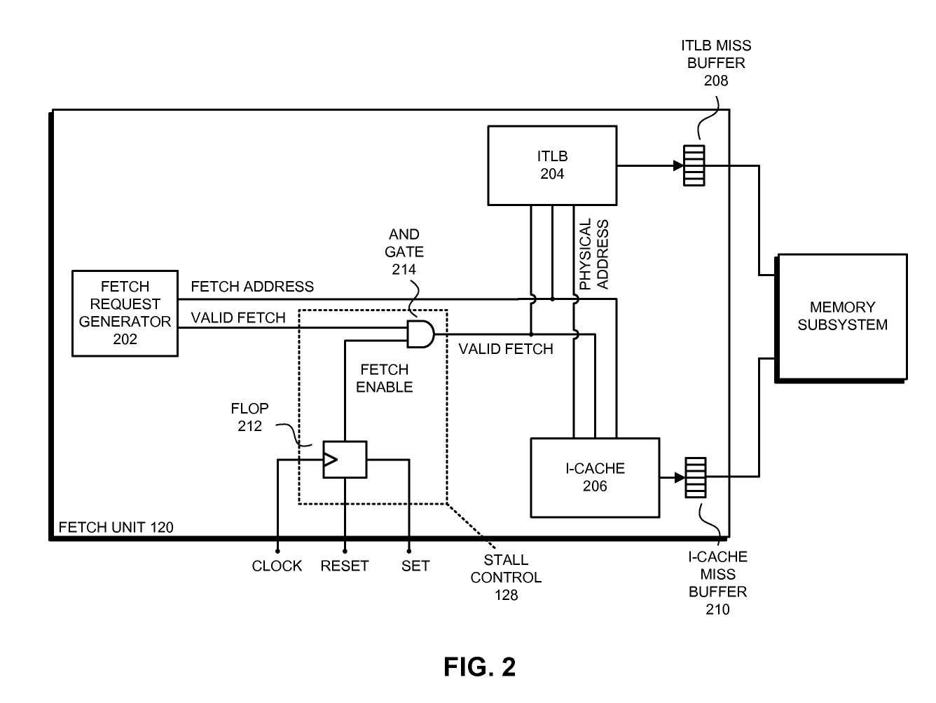

Mass-storage device 110, memory 108, L2 cache 106, and L1 cache 104 are computer-readable storage media that collectively form a memory hierarchy in a memory subsystem that stores data and instructions for processor 102. Generally, mass-storage device 110 is a high-capacity non-volatile memory, such as a disk drive or a large flash memory, with a large access time, while L1 cache 104, L2 cache 106, and memory 108 are smaller, faster semiconductor memories that store copies of frequently used data. For example, memory 108 can be a dynamic random access memory (DRAM) structure that is larger than L1 cache 104 and L2 cache 106, whereas L1 cache 104 and L2 cache 106 can include smaller static random access memories (SRAM). In some embodiments, L2 cache 106, memory 108, and mass-storage device 110 are shared among one or more processors in computer system 100. In addition, in some embodiments, L1 cache 104 comprises two separate caches, an instruction cache (see, e.g., I-cache 206 in FIG. 2) and a data cache, for separately storing cache lines containing instructions and data, respectively. Such memory structures are well-known in the art and are therefore not described in more detail.

In addition to the memory hierarchy, processor 102 includes one or more translation lookaside buffers (TLBs) (not shown in FIG. 1A) that are used to translate virtual addresses for cache lines into physical addresses in memory. ITLB 204 in FIG. 2 is one such TLB. However, processor 102 can also include a data TLB in pipeline 112. In addition, processor 102/computer system 100 may include a hierarchy of TLBs that includes a small TLB within pipeline 112, and one or more larger TLBs in different locations in computer system 100.

Computer system 100 can be incorporated into many different types of electronic devices. For example, computer system 100 can be part of a desktop computer, a laptop computer, a server, a media player, an appliance, a cellular phone, a piece of testing equipment, a network appliance, a calculator, a personal digital assistant (PDA), a hybrid device (i.e., a “smart phone”), a guidance system, a toy, audio/video electronics, a video game system, a control system (e.g., an automotive control system), or another electronic device.

Although we use specific components to describe computer system 100, in alternative embodiments, different components can be present in computer system 100. For example, computer system 100 can include video cards, network cards, optical drives, network controllers, I/O devices, and/or other peripheral devices that are coupled to processor 102 using a bus, a network, or another suitable communication channel. Alternatively, computer system 100 may include more or fewer of the elements shown in FIG. 1A. For example, computer system 100 may include additional processors 102, and the processors 102 may share some or all of L2 cache 106, memory 108, and mass-storage device 110 and/or may include some or all of their own memory hierarchy.

Note that, for clarity and brevity, in the following description, we use scout mode to describe the embodiments. However, the described embodiments are also operable with other forms of speculative execution. Generally, the described embodiments are operable with any form of speculative execution wherein, upon detecting a pipe-clearing event, processor 102 terminates speculative execution, restores a preserved pre-speculation architectural state, and resumes operation. The described embodiments facilitate preventing processor 102 and/or computer system 100 from sending needless memory requests (e.g., TLB instruction translation requests, cache line requests, etc.) during any mode of speculative execution once it becomes clear that a pipe-clearing event will cause the pre-speculation architectural state to be restored, rendering outstanding speculative memory requests useless.

FIGS. 1B and 1C present block diagrams of processor 102 in accordance with the described embodiments. The embodiments shown in both FIGS. 1B and 1C include mechanisms to enable processor 102 to detect impending pipe-clearing events and stall fetch unit 120 to prevent fetch unit 120 from fetching subsequent instructions. By stalling the fetch unit 120, the described embodiments also prevent fetch unit 120 from sending requests for TLB translations (i.e., page entry requests), cache line requests, and other memory requests based on attempts to translate instruction addresses, access cache lines for instructions, etc.

FIG. 1B illustrates embodiments where fetch unit 120 is stalled until a pipe-clearing instruction has passed commit/trap unit 126 and been finally resolved or until a pipe-clearing trap or error condition has been handled in processor 102, thereby ensuring that the pipe-clearing event can no longer affect pipeline 112 before fetching subsequent instructions. In contrast, FIG. 1C illustrates embodiments where fetch unit 120 is stalled until a stall condition that caused processor 102 to start executing instructions in the scout mode has been resolved (which can occur before, as, or after a pipe-clearing event is resolved). When the stall is released in both the embodiments shown in FIGS. 1B and 1C, processor 102 ends operation in the scout mode, restores a checkpoint, and resumes fetching instructions in a normal-execution mode. (Scout mode is described in more detail below.)

As shown in FIG. 1A, processor 102 includes pipeline 112 and L1 cache 104. As shown in both FIGS. 1B and 1C, pipeline 112 includes fetch unit 120, decode unit 122, execution unit 124, and commit/trap unit 126.

Generally, pipeline 112 is an instruction execution pipeline that includes a number of stages for executing program code. Within pipeline 112, fetch unit 120 fetches instructions from L1 cache 104 (or from other levels of the memory hierarchy) for execution. Next, decode unit 122 decodes the fetched instructions and prepares the instructions for execution in execution unit 124.

Execution unit 124 then executes the instructions forwarded from decode unit 122. Note that execution unit 124 can include one or more floating point execution units, integer execution units, branch execution units, and/or memory execution units (e.g., load-store units). Finally, commit/trap unit 126 retires successfully executed instructions (i.e., committing the results to the architectural state of processor 102 and computer system 100) and handles traps/errors that arise during the execution of instructions.

Note that in some embodiments, fetch unit 120 includes two separate pipeline stages. In these embodiments, the first stage is a TLB translation stage where fetch unit 120 translates a virtual instruction address into a physical address, and the second stage is an access to an instruction cache to retrieve the instruction using the translated address. However, for clarity, we include both sub-stages within the single fetch unit 120.

Note that pipeline 112 is simplified for the purposes of illustration. In alternative embodiments, pipeline 112 can contain other stages (units), functional blocks, mechanisms, and/or circuits. The units, functional blocks, mechanisms, and/or circuits that can be used in a pipeline are known in the art and hence are not described in more detail.

In the described embodiments, stall control 128 in fetch unit 120 includes one or more mechanisms for stalling fetch unit 120 to prevent instructions from being fetched. In some embodiments, while fetch unit 120 is stalled, pipeline 112 continues to run (i.e., the circuits in pipeline 112 are active), but no newly fetched instructions are forwarded from fetch unit 120 into decode unit 122. In some embodiments, while stalled, fetch unit 120 feeds no-ops (NOOPs) into pipeline 112.

In alternative embodiments, the output of fetch unit 120 continues to be set at a last fetched instruction value as long as fetch unit 120 is stalled. In these embodiments, pipeline 112 can simply continue to run, allowing whatever instruction is present on the output of fetch unit 120 to flow through pipeline 112 without allowing the results to affect the architectural state of processor 102. In the embodiments where pipeline 112 continues to pick up the last fetched instruction from fetch unit 120, processor 102 can include one or more mechanisms for preventing the results of instructions from affecting the architectural state of processor 102 while fetch unit 120 is stalled (not shown).

As shown in FIG. 1C, pipeline 112 also includes monitor unit 130. Monitor unit 130 monitors conditions for processor 102 and signals fetch unit 120 when an existing stall is to be released from fetch unit 120. For example, when a condition that caused processor 102 to start executing instructions in the scout mode (or speculatively executing instructions generally) has been resolved or when an operating condition (e.g., a mispredicted branch) monitor unit 130 causes the immediate flush of pipeline 112. Note that, although we show monitor unit 130 as a separate block in pipeline 112, in the described embodiments, some or all of monitor unit 130 can be located in one or more of the other sub-blocks of pipeline 112. For example, in some embodiments, a portion of monitor unit 130 can be contained in fetch unit 120, in decode unit 122, etc.

In the embodiments shown in FIGS. 1B-1C, processor 102 includes a SET signal and a RESET signal. When asserted, the SET signal enables fetch unit 120 to fetch instructions normally. In contrast, when asserted, the RESET signal causes stall control 128 to stall fetch unit 120 to prevent fetch unit 120 from fetching instructions and thereby potentially generating additional memory requests (e.g., cache line prefetches, TLB page entry requests, etc.). In order to release the stall, the SET signal can be asserted.

In the embodiments shown in FIGS. 1B-1C, the RESET signal is forwarded from each of the units in pipeline 112 (i.e., fetch unit 120, decode unit 122, execution unit 124, and commit/trap unit 126) to stall control 128. Upon detecting an indication of an impending pipe-clearing event, any of these units can assert the RESET signal to stall fetch unit 120.

In these embodiments, each of the units in pipeline 112 includes one or more mechanisms for detecting an indication of an impending pipe-clearing event. For example, execution unit 124 can include one or more mechanisms for determining when an instruction will generate a trap in the commit/trap unit 126. As another example, decode unit 122 can include one or more mechanisms for monitoring instruction decode to determine when a “pipe-clearing” instruction has been decoded.

In the embodiment shown in FIG. 1B, the SET signal is forwarded from commit/trap unit 126 to stall control 128. As described above, in the embodiment shown in FIG. 1B, fetch unit 120 is stalled until a pipe-clearing instruction, trap, or error condition has passed commit/trap unit 126 and is out of pipeline 112 (or has otherwise been handled by processor 102). Thus, when commit/trap unit 126 detects that a pipe-clearing condition has been handled, commit/trap unit 126 asserts the SET signal to release the stall from fetch unit 120 (i.e., to cause processor 102 to terminate the scout mode, restore a checkpoint, and resume execution in the normal-execution mode).

In the embodiment shown in FIG. 1C, the SET signal is forwarded from monitor unit 130 to stall control 128. As described above, in the embodiment shown in FIG. 1C, fetch unit 120 is stalled until a stall condition that caused processor 102 to start executing instructions in the scout mode has been resolved. In these embodiments, monitor unit 130 monitors conditions on processor 102 and asserts the SET signal to stall control 128 to release the stall from fetch unit 120 when the stall condition that caused processor 102 to enter the scout mode is resolved. In these embodiments, when releasing the stall, processor 102 to terminates the scout mode, restores a checkpoint, and resumes execution in the normal-execution mode.

Note that while instruction fetch unit 120 is stalled and hence not fetching instructions, instruction fetch unit 120 also does not send ITLB requests, cache line requests, or other types of memory requests based on the fetched instructions. This can facilitate the described embodiments avoiding sending duplicative requests based on repeatedly executed instructions. In addition, because instruction fetch unit 120 is stalled, other memory requests, such as data cache line requests or data translation lookaside buffer (DTLB) requests from the load-store execution unit in execution unit 124, are avoided because the fetch unit does not forward instructions to be decoded and executed.

In some embodiments, processor 102 includes a checkpoint-generation mechanism (not shown). This checkpoint-generation mechanism includes one or more register files, memories, tables, lists, or other structures that facilitate saving a copy of the architectural state of processor 102. In these embodiments, when commencing speculative execution, the checkpoint-generation mechanism can perform operations to checkpoint the architectural state of processor 102. Generally, the architectural state includes copies of all structures, memories, registers, flags, variables, counters, etc., that are useful or necessary for restarting processor 102 from the pre-speculation architectural state. Note that the checkpoint-generation mechanism may not immediately copy values to preserve the pre-speculation architectural state. In some embodiments, the state is only preserved as necessary. For example, before a register, counter, variable, etc. is overwritten or changed during speculative execution, the checkpoint-generation mechanism can preserve a copy. In some embodiments, the checkpoint-generation mechanism is distributed among one or more of the sub-blocks of processor 102.

Computer system 100 also includes functional blocks, circuits, and hardware for operating in a scout mode. Exemplary embodiments of a system that supports scout mode are described in U.S. Pat. Pub. No. 2004/0133769, entitled “Generating Prefetches by Speculatively Executing Code Through Hardware Scout Threading,” by inventors Shailender Chaudhry and Marc Tremblay, which is hereby incorporated by reference to describe scout mode mechanisms. Note that although we provide this reference as an example of a system that supports scout mode, numerous other references describe additional aspects of scout mode operation. See, for example, U.S. Pat. No. 7,529,911, entitled “Hardware-Based Technique for Improving the Effectiveness of Prefetching During Scout Mode,” by inventors Lawrence Spracklen, Yuan Chou, and Abraham Santosh, which is hereby incorporated by reference to describe scout mode mechanisms, along with other conference papers, patent publications, and issued patents.

In addition, in some embodiments, computer system 100 can include mechanisms (not shown) for operating in other speculative-execution modes. For example, processor 102 can include mechanisms for supporting execute-ahead mode, speculative branch prediction, and/or other forms of speculative execution.

FIG. 2 presents an expanded view of fetch unit 120 in accordance with the described embodiments. As shown in FIG. 2, fetch unit 120 includes fetch request generator 202, instruction translation lookaside buffer (ITLB) 204, and instruction cache (I-cache) 206.

Fetch request generator 202 generates fetch addresses for fetching cache lines containing instructions from I-cache 206. Generally, during operation fetch request generator 202 generates addresses for fetching cache lines in sequence from I-cache 206. However, instructions that cause processor 102 to jump or branch to another location in program code can cause fetch request generator 202 to generate addresses for fetching cache lines from corresponding and potentially non-sequential addresses in I-cache 206. Techniques for generating addresses for fetching cache lines are known in the art and are not described in more detail.

ITLB 204 is a lookup structure used by fetch unit 120 for translating virtual addresses of cache lines of instructions into the physical addresses where the cache lines are actually located in memory. ITLB 204 has a number of slots that contain page table entries that map virtual addresses to physical addresses. In some embodiments ITLB 204 is a content-addressable memory (CAM), in which the search key is the virtual address and the search result is a physical address. Generally, if a requested virtual address is present in ITLB 204 (an “ITLB hit”), ITLB 204 provides the corresponding physical address, which is then used to attempt to fetch the cache line from I-cache 206. Otherwise, if the virtual address is not present in ITLB 204 (an “ITLB miss”), the translation is performed using a high-latency “page walk,” which involves computing the physical address using one or more values retrieved from the memory subsystem. Note that in some embodiments, processor 102 requests the page entry from one or more higher levels of TLB (not shown) before performing the page walk.

ITLB miss buffer 208 is a memory that includes a number of entries for recording ITLB misses. In the described embodiments, when a virtual address lookup misses in ITLB 204, a request is sent to the memory subsystem to perform a page walk. The request is recorded in an entry in ITLB miss buffer 208. When a physical address is returned in response to an outstanding request, ITLB 204 can be updated and the entry in the ITLB miss buffer 208 can be cleared or invalidated.

I-cache 206 is a cache memory that stores a number of cache lines containing instructions. Generally, a request for a given cache line address can be sent to I-cache 206 to perform a lookup for the cache line. If the cache line is present in I-cache 206 (a “hit”), the cache line can be returned in response to the request. Otherwise, if the cache line is not present in I-cache 206 (a “miss”), the request can be forwarded to the next level in the memory subsystem.

I-cache miss buffer 210 is a memory that includes a number of entries for recording I-cache misses. In the described embodiments, when a lookup for a cache line misses in I-cache 206, a request is sent to the memory subsystem for the cache line. The request is recorded in an entry in I-cache miss buffer 210. When a cache line is returned in response to an outstanding request, I-cache 206 can be updated and the entry in the I-cache miss buffer 210 can be cleared or invalidated.

Fetch request generator 202 includes two output signals: FETCH_ADDRESS and VALID_FETCH. The FETCH_ADDRESS signal is a multi-bit signal (e.g., 24, 32, or 64 bits) for signaling an address that is to be used to fetch a cache line containing instructions from I-cache 206. In some embodiments, the address on FETCH_ADDRESS can be: (1) a physical address, which can be used to retrieve cache lines from I-cache 206 directly, or (2) a virtual address, which is translated into a physical address in ITLB 204 before the physical address is used to retrieve cache lines from I-cache 206.

The VALID_FETCH signal is a single-bit signal that can be used by fetch request generator 202 to indicate that the signal on FETCH_ADDRESS is a valid address signal that can be used to perform address translations and/or retrieve cache lines.

Flop 212 is a circuit element (e.g., a set-reset (SR) flip-flop) that is used to control whether fetch unit 120 is stalled and therefore not fetching instructions, or operating normally and therefore fetching instructions. When the FETCH_ENABLE of flop 212 is deasserted (i.e., a logical “0”), AND gate 214 deasserts the VALID_FETCH output, which prevents ITLB 204 from translating a virtual address on FETCH_ADDRESS to a physical address, and prevents I-cache 206 from returning cache lines based on FETCH_ADDRESS and/or the physical address from ITLB 204.

As shown in FIGS. 1B-1C, the values on the SET and RESET inputs to flop 212 (i.e., to stall control 128) are controlled by one or more of the other units in processor 102. Upon detecting an impending pipe-clearing event, the other units can assert the RESET signal to reset FETCH_ENABLE to “0,” thereby stalling fetch unit 120. Upon detecting the resolution of the pipe-clearing event, the other units can assert the SET signal to set FETCH_ENABLE to “1” to release the stall and enable fetch unit 120 to continue fetching instructions. Recall that depending on the embodiment the resolution of the pipe-clearing event can include: (1) the retirement of a pipe-clearing instruction; or (2) the resolution of the stall condition that caused processor 102 to enter the scout mode. Note also that in some embodiments one of the sub-blocks in processor 102 (e.g., monitor unit 130) can assert the SET signal to release a stall on fetch unit 120 in the event that an operating condition (e.g., error, branch misprediction, etc.) prevents the pipe-clearing event from being handled/completed by processor 102.

In some embodiments, the units in processor 102 are configured so that the SET and RESET signals cannot be asserted at the same time to avoid race conditions between the SET and RESET signals. For example, in some embodiments, the units in processor 102 can assert the SET and RESET signals only for a predetermined time (i.e., the SET and RESET signals are strobed).

Although we describe embodiments with separate SET and RESET signals, alternative embodiments can use different mechanisms and signals and/or combinations of signals to cause fetch unit 120 to stall in response to detecting an impending pipe-clearing event. For example, in some alternative embodiments, the SET and RESET signals are replaced by a single STALL_DISABLE signal (not shown). In these embodiments, upon detecting an indicator of a pipe-clearing event, a given unit in pipeline 112 can deassert (i.e., set to a logical “0”) the STALL_DISABLE signal. In these embodiments, the STALL_DISABLE signal can then be held deasserted by a weak keeper (not shown). When the unit or another unit in pipeline 112 subsequently determines that the pipe-clearing event has been resolved, the STALL_DISABLE signal can be asserted (thereby overriding the weak keeper) to release the stall. The STALL_DISABLE signal can then be held in the asserted state by the weak keeper. In these embodiments, the STALL_DISABLE signal can be directly fed to AND gate 214 to enable the stall control.

In addition, in some embodiments, flop 212 is replaced with another circuit element for controlling the stall of instruction fetch unit 120. As one possible example, using the single STALL_DISABLE signal described above, some embodiments can use an enable flop, which is a flop with a single data input and an enable signal. In these embodiments, by deasserting the enable signal the flop can be disabled to prevent the stall from occurring. Otherwise, the enable flop passes the value on the STALL_DISABLE signal to AND gate 214.

The blocks and functional elements shown in FIG. 2 are simplified for the purpose of illustration. In some embodiments, fetch unit 120 may contain more or fewer elements and/or functional blocks. In addition, in some embodiments, the blocks and functional elements can include more or fewer inputs (e.g., address inputs, etc.) and/or outputs. In addition, as described above, in some embodiments, instruction fetch unit 120 is divided across two separate pipeline stages. In these embodiments, a virtual address is translated to a physical address using ITLB 204 in a first pipeline stage, and then the translated address is used to access I-cache 206 in a second pipeline stage.

### Scout Mode

In the described embodiments, processor 102 supports scout mode. Generally, scout mode is a form of speculative execution during which processor 102 executes program code to prefetch cache lines and update other processor state, but does not commit results to the architectural state of processor 102.

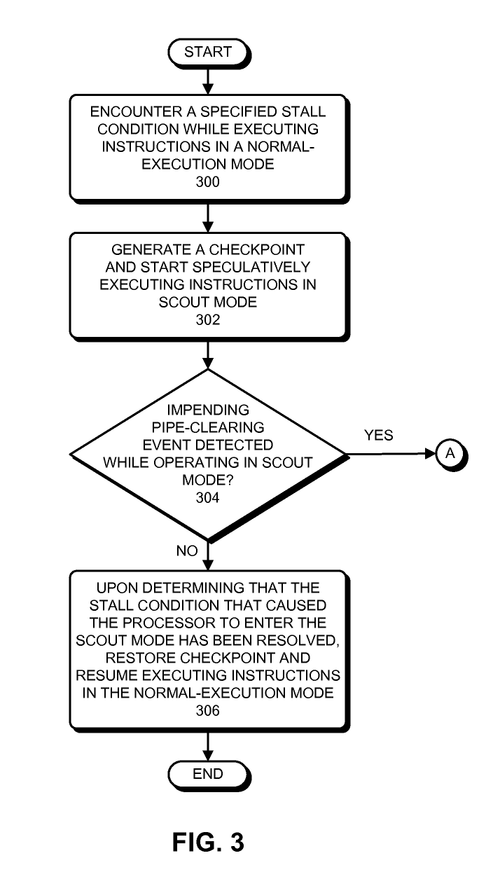

FIG. 3 presents a flowchart illustrating a process for operating in scout mode in accordance with the described embodiments. As shown in FIG. 3, upon encountering a specified stall condition while executing program code (step 300), processor 102 generates a checkpoint to preserve the architectural state of processor 102 and then enters scout mode (step 302).

While operating in scout mode, processor 102 speculatively executes the code from the point of the stall without committing results of the speculative execution to the architectural state of processor 102. If processor 102 encounters a memory reference while operating in scout mode, processor 102 determines if a target address for the memory reference can be resolved. If so, processor 102 issues a prefetch for the memory reference to load a cache line for the memory reference into a cache (e.g., L1 cache 104). In addition to issuing prefetches for cache lines, processor 102 can update other memories or processor structures for which an update can be resolved. For example, processor 102 can update translation lookaside buffer (TLB) page table entries, branch predictions in a branch prediction unit, and/or other memories or tables.

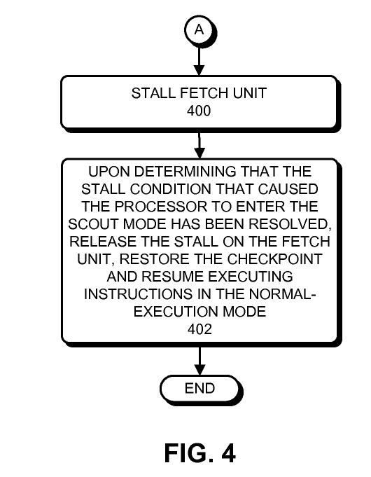

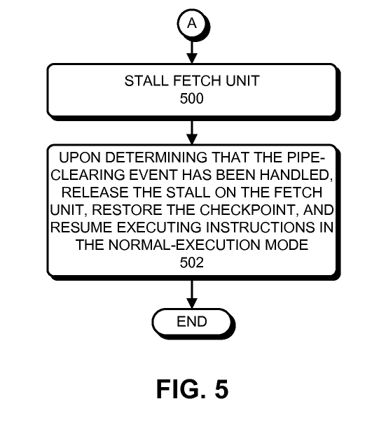

While processor 102 is operating in scout mode, upon detection by one of the units in pipeline 112 of an impending “pipe-clearing” event (step 304), the unit in pipeline 112 can stall fetch unit 120 to prevent fetch unit 120 from fetching instructions during the pipe-clearing event (for details about how fetch unit 120 is stalled, and the stall on fetch unit 120 is released, see FIGS. 4-5, which describe how the stall condition can be handled in different embodiments, i.e., from point “A” in FIG. 3).

Generally, a pipe-clearing event is a condition encountered by the processor for which some or all of pipeline 112 stages are cleared. For example, one type of pipe-clearing event is a “pipe-clearing” instruction, which includes any instruction for which the processor clears pipeline stages behind the instruction and keeps pipeline 112 stages behind the instruction clear until the instruction completes execution (e.g., the DONE, RETRY, WRPR, or WRY instructions in the SPARC processor architecture from SPARC International Inc., of Menlo Park, Calif., USA). Another example of a pipe-clearing event includes error conditions or traps. For example, upon encountering a divide instruction for which the denominator is zero, the processor generates a divide-by-zero trap, which clears pipeline 112 and branches to trap-handling code.

When monitor unit 130 determines that the stall condition has been resolved, the processor clears pipeline 112, restores the checkpoint, and resumes execution in a normal-execution mode (step 306). Note that restoring the checkpoint and resuming execution in the normal-execution mode can involve re-executing some or all of the instructions executed during scout mode.

In these embodiments, executing in scout mode past the stall condition enables processor 102 to “warm up” caches, memories, tables, and other processor structures using speculatively executed instructions. The warmed-up structures can subsequently be used to enable more efficient execution upon resuming execution in the normal-execution mode.

Although we use scout mode as an exemplary speculative-execution mode, alternative embodiments of processor 102 support different speculative-execution modes (e.g., execute-ahead mode, speculative branch prediction, etc.). The alternative embodiments operate in a similar way to the described embodiments.

Note that the described embodiments differ from existing systems that support scout mode in that processor 102 does not immediately terminate scout mode in the event that a pipe-clearing event occurs in processor 102. Instead, in these embodiments, processor 102 detects an impending pipe-clearing event and stalls fetch unit 120 at least until the pipe-clearing event is handled. In some of these embodiments, processor 102 can eventually resume operation in scout mode (see, e.g., the embodiment shown in FIG. 1B).

Note also that the described embodiments support a normal-execution mode, in which program code is executed in program order. Normal execution (i.e., operating in the normal-execution mode) is known in the art and hence is not described in detail.

### Processes for Stalling the Fetch Unit Upon Detecting a Pipe-Clearing Event

FIGS. 4-5 present flowcharts illustrating processes for stalling fetch unit 120 upon detecting an impending pipe-clearing event in accordance with the described embodiments. More specifically, FIGS. 4-5 illustrate when a stall of fetch unit 120 that is triggered upon encountering an impending pipe-clearing event during scout mode is released in the described embodiments.

In the embodiment shown in FIG. 4, once stalled during scout mode, the stall of fetch unit 120 is not released until the stall condition that caused the processor to start executing in the scout mode is resolved. In contrast, in the embodiment shown in FIG. 5, when stalled during scout mode, the stall of fetch unit 120 is released as soon as the pipe-clearing event has been handled by processor 102. In both the embodiment shown in FIG. 4 and the embodiment shown in FIG. 5, when releasing the stall of fetch unit 120, processor 102 terminates scout mode, restores the checkpoint generated when starting scout mode, and resumes fetching instructions for execution in the normal-execution mode.

Note that while instruction fetch unit 120 is stalled and hence not fetching instructions, instruction fetch unit 120 also does not send TLB requests, cache line requests, or other types of memory requests based on the fetched instructions. In addition, because instruction fetch unit 120 is stalled, the load-store execution unit in execution unit 124 does not send memory requests such as data cache line requests or data translation lookaside buffer (DTLB) requests (because instruction fetch unit 120 is stalled and therefore not forwarding instructions to be decoded and executed). This can facilitate the described embodiments avoiding sending duplicative memory requests based on repeatedly executed instructions.

Recall that as described above, the processes shown in FIGS. 4-5 start after processor 102 has detected an impending pipe-clearing condition while operating in scout mode (i.e., step 400 in FIG. 4 and step 500 in FIG. 5 proceed from point “A” in FIG. 3, following a “YES” condition in step 304.)

As shown in FIG. 4, upon detecting an impending pipe-clearing event while operating in scout mode, the unit in pipeline 112 that detected the impending pipe-clearing event asserts the RESET signal to stall fetch unit 120 (step 400). Generally, as long as fetch unit 120 is stalled, fetch unit 120 does not fetch new instructions for execution in pipeline 112. As described above, fetch unit 120 can forward predetermined instructions (e.g., NOOPs) into pipeline 112. Alternatively, fetch unit 120 can continue to place the last fetched instructions into pipeline 112 (and pipeline 112 can include one or more mechanisms for ignoring or cancelling the effect of instructions issued while fetch unit 120 is stalled.)

Note that, although we use the SET and RESET signals to describe these embodiments, in alternative embodiments, different signals and/or mechanisms can be used to stall fetch unit 120.

Upon monitor unit 130 determining that the stall condition that caused processor 102 to start operating in scout mode has been resolved, monitor unit 130 releases the stall on fetch unit 120, and signals processor 102 to restore the checkpoint and resume executing instructions in the normal-execution mode (step 402). In other words, upon monitor unit 130 detecting the resolution of the stall condition that caused processor 102 to start a scout mode episode, monitor unit 130 causes processor 102 to end the scout mode episode as described above. However, in addition to performing the operations for ending the scout mode episode, monitor unit 130 in processor 102 also asserts the SET signal to release the stall on fetch unit 120. In these embodiments, the stall of fetch unit 120 is released in conjunction with the resumption of the operation in the normal-execution mode so that fetch unit 120 begins fetching instructions for execution in normal-execution mode.

As shown in FIG. 5, upon detecting an impending pipe-clearing event while operating in scout mode, the unit in pipeline 112 that detected the impending pipe-clearing event asserts the RESET signal to stall fetch unit 120 (step 500).

Upon determination by commit/trap unit 126 that the pipe-clearing event has been handled, commit/trap unit 126 asserts the SET signal to release the stall on fetch unit 120 and cause processor 102 to restore the checkpoint, and resume executing instructions in the normal-execution mode (step 502). In other words, upon commit/trap unit 126 detecting that the pipe-clearing event has been handled, processor 102 ends the scout mode episode as described above. In these embodiments, commit/trap unit 126 releases the stall of fetch unit 120 in conjunction with the resumption of the operation in the normal-execution mode so that fetch unit 120 begins fetching instructions for execution in normal-execution mode.

In these embodiments, a pipe-clearing event has been handled as soon as the instruction, operating condition, or error that was detected by a unit in pipeline 112 as indicating an impending pipe-clearing event has caused the pipe-clearing event and/or retired from pipeline 112. For example, assuming that the pipe-clearing event is caused by a pipe-clearing instruction, the pipe-clearing event is considered handled as soon as the pipe-clearing instruction passes the commit/trap unit 126 and is no longer in pipeline 112. As another example, when an instruction that caused a trap condition has been processed in commit/trap unit 126 (i.e., has caused a flush of pipeline 112 and is finished with processing), the pipe-clearing event is considered handled.

In some of the embodiments described with respect to FIG. 5, if the stall condition that caused processor 102 to enter the scout mode is resolved, processor 102 can immediately restore the checkpoint and resume execution in the normal-execution mode (i.e., can end the scout mode episode, as is described above with respect to scout mode, regardless of whether fetch unit 120 is stalled). In addition, a unit in pipeline 112 (e.g., monitor unit 130 or another sub-block in processor 102) can detect the resolution of the stall condition that caused processor 102 to enter the scout mode and assert the SET signal to immediately release any outstanding stall of fetch unit 120.

In these embodiments, the SET signal can be asserted whether there is an outstanding stall or not (note that the assertion of the SET signal if flop 212 is already “set” has no effect). In other words, in these embodiments, the unit in pipeline 112 automatically asserts the SET signal to ensure that any stall of fetch unit 120 is released before returning to normal-execution mode.

### Per-Strand Stalls

In some embodiments, processor 102 includes mechanisms for executing two or more strands (where a “strand” includes hardware mechanisms for executing a software thread). In some of these embodiments, fetch unit 120 includes mechanisms for controlling the fetching of instructions on a per-strand basis. These embodiments can include mechanisms to enable the stalling of fetch unit 120 for a given strand (i.e., a “per-strand” stall of the fetch unit). In these embodiments, upon detecting an impending pipe-clearing event for a given strand, the units in pipeline 112 can stall fetch unit 120 to prevent fetch unit 120 from fetching subsequent instructions for the corresponding strand until the pipe-clearing event has been handled for that strand. The per-strand stall can then be released, enabling fetch unit 120 to resume fetching instructions for the strand.

### Alternative Forms of Speculative Execution

In some embodiments, processor 102 supports one or more additional forms of speculative execution. Generally, these forms of speculative execution include any operational mode wherein processor 102 executes instructions speculatively and can return to a prior operating state (i.e., can return to a checkpoint, rewind a transaction, etc.) upon encountering a pipe-clearing event. For example, these speculative-execution modes can include execute-ahead mode, speculative branch-prediction mode, transactional execution mode, or other such speculative-execution modes.

Embodiments of processor 102 that support other forms of speculative execution operate in a similar way to the above-described embodiments. Specifically, upon detecting that a predetermined pipe-clearing event is going to occur, these embodiments can stall fetch unit 120 to prevent instructions from being fetched and executed until the pipe-clearing event has been handled by processor 102. Once the pipe-clearing event has been handled, these embodiments can release the stall on fetch unit 120 to enable the fetch unit to resume fetching instructions.

### Releasing a Stall in the Fetch Unit

Some of the described embodiments include one or more mechanisms for releasing the stall of the fetch unit in case an event occurs that would otherwise prevent the processor from completing the execution of the pipe-clearing event and releasing the stall. For example, in the case of a branch misprediction, processor 102 immediately flushes pipeline 112 and jumps to a new location in the program code to begin fetching subsequent instructions. Because pipeline 112 flushes can remove the instruction and/or operating condition that caused a pending pipe-clearing event from pipeline 112, commit/trap unit 126 may never encounter/handle the pipe-clearing event, and thus may never release the stall on fetch unit 120 (deadlocking the processor). Thus, in some of the described embodiments, upon encountering the branch mispredict, processor 102 (e.g., monitor unit 130 or one of the units in pipeline 112) releases the stall from fetch unit 120. Although we use branch misprediction to describe these embodiments, other embodiments immediately release the stall based on other operating conditions, such as, but not limited to, the return of another pipe-clearing event.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. A method for executing instructions in a processor, comprising:
speculatively executing instructions in the processor in a speculative-execution mode; and
in response to detecting a pipe-clearing event while executing instructions in the speculative-execution mode, stalling an instruction fetch unit to prevent the instruction fetch unit from fetching additional speculative instructions.

2. The method of claim 1, wherein stalling the instruction fetch unit comprises:
maintaining the stall of the instruction fetch unit until a condition that originally caused the processor to operate in the speculative-execution mode is resolved; and
releasing the stall of the instruction fetch unit when the condition is resolved.

3. The method of claim 2, wherein before releasing the stall of the instruction fetch unit, the method further comprises:
restoring the processor to a preserved architectural state that existed before commencing execution of instructions in the speculative-execution mode; and
resuming operation in a normal-execution mode.

4. The method of claim 1, wherein stalling the instruction fetch unit involves:
maintaining the stall of the instruction fetch unit until the pipe-clearing event has been completed; and
releasing the stall of the instruction fetch unit when the pipe-clearing event has been completed.

5. The method of claim 1, wherein speculatively executing instructions involves:
using one strand from a set of two or more strands on the processor to speculatively execute the instructions; and
in response to detecting a pipe-clearing event for the strand, performing a per-strand stall in the instruction fetch unit to prevent the instruction fetch unit from fetching additional speculative instructions for the strand.

6. The method of claim 1, wherein the method further comprises:
releasing the stall of the instruction fetch unit when an instruction or operating condition prevents the pipe-clearing event from being completed.

7. The method of claim 1, wherein speculatively executing instructions involves executing instructions in a scout mode, an execute-ahead mode, a branch-prediction mode, or in another speculative-execution mode.

8. The method of claim 1, wherein the pipe-clearing event is caused by at least one of:
a pipe-clearing instruction;
a trap condition;
a miss for a delay slot for a branch; or
an operating condition that will cause the clearing of one or more stages of a pipeline in the processor.

9. An apparatus for executing instructions, comprising:
a processor;
a pipeline within the processor, wherein the processor is configured to use the pipeline to execute instructions; and
an instruction fetch unit in the pipeline, wherein the instruction fetch unit is configured to fetch the instructions for execution;
wherein the processor is configured to:
speculatively execute instructions in a speculative-execution mode using the pipeline; and
in response to detecting a pipe-clearing event while executing instructions in the speculative-execution mode, stall the instruction fetch unit to prevent the instruction fetch unit from fetching additional speculative instructions.

10. The apparatus of claim 9, wherein the processor is further configured to:
maintain the stall of the instruction fetch unit until a condition that originally caused the processor to operate in the speculative-execution mode is resolved; and
release the stall of the instruction fetch unit when the condition is resolved.

11. The apparatus of claim 10, wherein before releasing the stall of the instruction fetch unit, the processor is configured to:
restore the processor to a preserved architectural state that existed just before starting executing instructions in the speculative-execution mode; and
resume operation in a normal-execution mode.

12. The apparatus of claim 9, wherein the processor is further configured to:
maintain the stall of the instruction fetch unit until the pipe-clearing event has been completed; and
release the stall of the instruction fetch unit when the pipe-clearing event has been completed.

13. The apparatus of claim 9, wherein the processor is configured to support two or more strands for executing instructions on the processor;
wherein the processor is configured to use one of the two or more strands to speculatively execute instructions; and
in response to detecting the pipe-clearing event for the strand, the processor is configured to perform a per-strand stall in the instruction fetch unit to prevent the instruction fetch unit from fetching instructions for the strand.

14. The apparatus of claim 9, wherein the processor is further configured to release the stall of the instruction fetch unit when an instruction or operating condition prevents the pipe-clearing event from being completed.

15. The apparatus of claim 9, wherein when speculatively executing instructions, the processor is configured to execute instructions in a scout mode, an execute-ahead mode, a branch-prediction mode, or in another speculative-execution mode.

16. The apparatus of claim 9, wherein the processor is configured so that the pipe-clearing event is triggered by at least one of:
a pipe-clearing instruction;
a trap condition;
a miss for a delay slot for a branch; or
an operating condition that will cause the clearing of one or more stages of a pipeline in the processor.

17. A computer system for executing instructions, comprising:
a processor;
a memory coupled to the processor, wherein the memory stores instructions and data for the processor;
a pipeline within the processor, wherein the processor is configured to use the pipeline to execute instructions; and
an instruction fetch unit in the pipeline, wherein the instruction fetch unit is configured to fetch the instructions for execution;
wherein the processor is configured to:
speculatively execute instructions in a speculative-execution mode using the pipeline; and
in response to detecting a pipe-clearing event while executing instructions in the speculative-execution mode, stall the instruction fetch unit to prevent the instruction fetch unit from fetching additional speculative instructions.

18. The computer system of claim 17, wherein the processor is further configured to:
maintain the stall of the instruction fetch unit until a condition that originally caused the processor to operate in the speculative-execution mode is resolved; and
release the stall of the instruction fetch unit when the condition is resolved.

19. The computer system of claim 17, wherein the processor is further configured to:
maintain the stall of the instruction fetch unit until the pipe-clearing event has been completed; and
release the stall of the instruction fetch unit when the pipe-clearing event has been completed.

20. The computer system of claim 17, wherein the processor is further configured to release the stall of the instruction fetch unit when an instruction or operating condition prevents the pipe-clearing event from being completed.
